(19) United States
(12) Patent Application Publication
(10) Pub. No.: US 2026/0361565 A1
(43) Pub. Date: Nov. 12, 2026

(54) END-OF-TRANSMISSION DETECTION IN ETHERNET INTERFACE

(71) Applicant: Cisco Technology, Inc., San Jose, CA (US)

(72) Inventors: Thomas Helmut Toifl, Gattikon (CH); Aviran Kadosh, Moreshet (IL); Shai Erez, Tzofit (IL); Mor Levi, Gan Yavne (IL); Naor Goldman, Tzur Moshe (IL)

(21) Appl. No.: 19/204,269

(22) Filed: May 9, 2025

(51) Int. Cl. H04L 12/40; H04L 12/12

(52) U.S. Cl. CPC H04L 12/40039; H04L 12/12

(57) ABSTRACT

Systems, devices, and methods for detecting an end-of-transmission in an Ethernet interface are provided. A transmitting network device transmits a data frame including one or more packets. The transmitting network device generates an indication specifying an end-of-transmission. The indication includes a first pattern with a missing pulse followed by a second pattern. The second pattern exhibits energy below a threshold value. The transmitting network device transmits the indication following a last packet of the data frame. A receiving network device receives the data frame and the indication. The receiving network device determines an edge position of the first pattern, detects a potential last bit of the data frame based on the missing pulse of the first pattern and the edge position of the first pattern, and evaluates data that follows the potential last bit. The receiving network device detects the end-of-transmission based on the evaluation of the data.

The present disclosure relates to power management. More particularly, the present disclosure relates to detecting an end-of-transmission in an Ethernet interface.

### BACKGROUND

With the advancement of digital technologies and increasing dependence on networks, network devices including, for example, switches, routers, access points, servers, or the like, continue to grow in number, performance, and usage, resulting in increased power consumption. In high-performance network devices such as switches and routers, excessive power consumption may lead to higher temperatures, which can affect the reliability and longevity of hardware. Efficient power use may improve the feasibility to deploy large numbers of network devices without overwhelming power infrastructure, while also making it easier to scale the networks without excessive energy costs. Further, reducing power consumption may help decrease the carbon footprint of network operations, contributing to sustainability goals.

In network devices such as switches, about 70%-90% of idle power may be due to Serializer/Deserializer (SerDes) and Ethernet ports. A SerDes, typically utilized for high-speed communication applications, may include an electronic circuit that transforms parallel data into serial data and vice versa. The SerDes may operate or stay powered-up continuously, even when not actively transmitting or receiving data because a time for obtaining a phase lock and calibrating a Digital Signal Processor (DSP) in a receiver may be too long if the SerDes starts up from a completely powered-down state. Idle power, which may include power consumed when there is no data traffic, may be substantially high. While higher layers of an Ethernet interface may utilize clock gating techniques for reducing power consumption when there is no data traffic, lower layers may continue to process incoming idle data patterns and to consume power. A large fraction of this power can be saved by rapidly turning on and off the SerDes. However, this requires a method to detect an end-of-transmission at the receiver to allow the receiver to determine when the receiver can turn itself on and off, and distinguish correct data boundaries.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a communication layer architecture in accordance with various embodiments of the disclosure;

FIG. 2 is a block diagram of a system for detecting an end-of-transmission in an Ethernet interface in accordance with various embodiments of the disclosure;

FIG. 3 is a timing diagram for detecting an end-of-transmission in an Ethernet interface in accordance with various embodiments of the disclosure;

FIG. 4 is a schematic diagram of a clock pattern with a missing pulse configured to identify an end-of-transmission in accordance with various embodiments of the disclosure;

FIG. 5 is a flowchart depicting a process for indicating an end-of-transmission in accordance with various embodiments of the disclosure;

FIG. 6 is a flowchart depicting a process for transmitting an indication specifying an end-of-transmission during a transition from a power-up state to a power-down state in accordance with various embodiments of the disclosure;

FIG. 7 is a flowchart depicting a process for detecting an end-of-transmission in an Ethernet interface in accordance with various embodiments of the disclosure;

FIG. 8 is a flowchart depicting a process for managing power of an Ethernet interface based on detection of an end-of-transmission in accordance with various embodiments of the disclosure; and

FIG. 9 is a conceptual block diagram of a device suitable for configuration with a power management logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DESCRIPTION OF EXAMPLE EMBODIMENTS

### Overview

In many embodiments, a method comprises transmitting a data frame comprising one or more packets, generating an indication specifying an end-of-transmission, wherein the indication comprises a first pattern with a missing pulse followed by a second pattern, and transmitting the indication following a last packet of the one or more packets of the data frame.

In a number of embodiments, a transmitting network device comprises one or more processors, a memory communicatively coupled to the one or more processors, and a power management logic. The memory includes the power management logic is configured to transmit a data frame comprising one or more packets. The power management logic is further configured to generate an indication specifying an end-of-transmission. The indication comprises a first pattern with a missing pulse followed by a second pattern. The power management logic is further configured to transmit the indication following a last packet of the one or more packets of the data frame.

### Example Embodiments

In response to the issues described above, systems, devices, and methods are discussed herein for detecting an end-of-transmission in an Ethernet interface. Ethernet may refer to a communication standard, for example, the Institute of Electrical and Electronics Engineers (IEEE) 802.3 standard, based on an access control mechanism such as a Carrier Sense Multiple Access/Collision Detection (CSMA/CD) protocol, utilized for connecting network devices in a wired Local Area Network (LAN) or a Wide Area Network (WAN) and for transmitting data over both wired and wireless network connections. The Ethernet may operate at a data link layer of an Open Systems Interconnection (OSI) model, with some elements operating at a physical (PHY) layer. The Ethernet interface may refer to a network interface that allows a network device to connect and communicate with other network devices over an Ethernet network. The Ethernet interface may allow the network device to transmit and receive data over the Ethernet network using Ethernet protocols. The Ethernet interface may include, for example, a physical interface or a port for plugging an Ethernet cable, a hardware component such as a Network Interface Controller (NIC), and a Media Access Control (MAC) address configured to direct the data to a target network device.

The Ethernet interface implemented, for example, with high-speed Ethernet standards such as 1 Gigabit (1 G) Ethernet, 10 G Ethernet, 40 G Ethernet, 100 G Ethernet, or the like, may incorporate Serializer/Deserializer (SerDes) circuitry. The SerDes circuitry may include a SerDes transmitter at a transmitter side of the Ethernet interface, and a SerDes receiver at a receiver side of the Ethernet interface. The SerDes circuitry may convert parallel data streams from an Ethernet MAC layer into serial data, at the transmitter side, for transmission over a physical medium, and may convert the serial data into parallel data at the receiver side. The physical medium may include, for example, copper cables, fiber optic cables, or the like. The SerDes circuitry may be embedded, for example, in an Ethernet PHY layer chip, configured for electrical and physical transmission of data over the physical medium.

The SerDes circuitry may allow high-speed data transmission over long distances by optimally packing and unpacking the data. The Ethernet MAC layer may frame, address, and perform error checking of the data. Further, the Ethernet MAC layer may transmit the data, for example, as Ethernet frames in a parallel form, herein referred to as “parallel data,” to the SerDes circuitry for serialization. The SerDes transmitter may be configured to perform the serialization. The SerDes receiver may be configured to perform deserialization. The SerDes transmitter may receive the parallel data from the Ethernet MAC layer, convert the received parallel data into a serial data stream, and transmit the serial data stream to the SerDes receiver. The SerDes receiver may receive and reconstruct the incoming serial data stream back into parallel data that the Ethernet MAC layer can process. The SerDes receiver may transmit the reconstructed parallel data to the Ethernet MAC layer for further processing including, for example, error checking by utilizing a Cyclic Redundancy Check (CRC), de-framing, and forwarding the reconstructed parallel data to higher layers in a networking stack. The SerDes receiver may include a Clock Data Recovery (CDR) mechanism that extracts a clock signal from the incoming serial data stream for synchronizing the data.

In network devices such as switches, about 70%-90% of idle power may be due to SerDes and Ethernet ports. The SerDes circuitry may operate or stay powered-up continuously, even when not actively transmitting or receiving data because a time for obtaining a phase lock and calibrating a Digital Signal Processor (DSP) in a receiver may be too long if the SerDes circuitry starts up from a completely powered-down state. Continuously operating in the powered-up state, even when there is no data traffic, may increase power consumption. Idle power, which may include power consumed when there is no data traffic, may be substantially high. While higher layers of the Ethernet interface may utilize clock gating techniques for reducing power consumption when there is no data traffic, lower layers may continue to process incoming idle data patterns and to consume power.

Conventional power-saving techniques may primarily focus on reducing Central Processing Unit (CPU) and memory power consumption. However, these techniques may often overlook a persistent energy drain caused by the SerDes circuitry and Ethernet links. The SerDes circuitry and the Ethernet links may remain active by default, consuming substantial power even in the absence of data traffic. Although an Energy Efficient Ethernet (EEE) protocol may provide for low-power operations to dynamically scale down power usage while preserving link reliability, time constants in EEE are substantially high, which may make EEE unsuitable for low-latency networking and may lead to a large power overhead when data packet sizes are small. A large fraction of power can be saved by rapidly powering down or powering up the SerDes circuitry. However, this requires a method for detecting an end-of-transmission at the receiver to allow the receiver to determine when the receiver can power itself down and up, and distinguish correct data boundaries, for example, determine which transmitted bits are part of a transmitted data frame.

The present disclosure addresses the above-mentioned need for systems, devices, and methods for detecting an end-of-transmission in an Ethernet interface. Typically, networks may be provisioned based on a need for a maximum throughput. When there is less data traffic, not every link in a network needs to operate. Dynamically powering down or powering up the SerDes circuitry can reclaim the power consumed for maintaining the links active when there is no data to transmit. Therefore, there is a need for reliably detecting when a transmitted data frame ends. The systems, devices, and methods discussed herein may provide a power management logic configured to detect an end-of-transmission in an Ethernet interface. In many embodiments, the systems, devices, and methods discussed herein may signal an end-of-transmission for a burst mode of transmission. The burst mode of transmission may refer to a method for transmitting data in rapid, high-speed bursts instead of in a continuous stream. During each burst, a large amount of data may be transmitted over a short period, followed by a pause or idle time before a subsequent burst begins. By performing a reliable detection of the end-of-transmission, the power management logic may substantially reduce the probability of an inaccurate detection of the end-of-transmission. In a number of embodiments, the power management logic may determine non-data information in a random stream of symbols, for example, Pulse Amplitude Modulation (PAM) symbols. PAM may encode data by varying an amplitude level or a voltage of each pulse. Each unique amplitude level may correspond to a symbol. A PAM symbol may refer to a discrete voltage or amplitude level utilized to represent digital data in PAM systems. Each PAM symbol may correspond to a specific voltage or amplitude level. The PAM symbol may be defined by utilizing different PAM schemes, for example, a PAM-2 modulation, a PAM-4 modulation, a PAM-6 modulation, a PAM-8 modulation, or a Quadrature Amplitude Modulation (QAM). In a variety of embodiments, the power management logic may detect a symbol at which a data frame ends, thereby increasing precision of the end-of-transmission at a symbol level.

In various embodiments, when a transmitting network device, herein referred to as a “transmitter,” completes transmitting a data frame, the transmitter may transmit a first pattern with a missing pulse to a receiving network device, herein referred to as a “receiver,” and then transition from a power-up state to a power-down state. The power-up state may refer to an operational state that a component, for example, transmitting circuitry, receiving circuitry, or the like, enters when the component is powered on and initialized for normal data communication including data transmission and data reception. The power-up state may be an active high power consuming state of a network device, when the network device is functioning in its full capacity. The power-down state may refer to a low-power state in which a component powers down or completely shuts off its internal circuits and functions to save power when the component is not actively transmitting or receiving data, for example, when the network device is idle. In more embodiments, the first pattern may correspond to a clock pattern with a missing pulse at the end of the first pattern. For example, a single clock pulse may be missing before the transmitter transitions to the power-down state. In additional embodiments, the receiver may detect a potential last bit based on the detection of the missing pulse at the end of the first pattern. The receiver may then measure energy of data that follows the potential last bit, for example, the energy of consecutive symbols that follow the potential last bit, and if the energy is found to be below a threshold value, the receiver may reliably detect the end-of-transmission.

In further embodiments, the power management logic may signal the end-of-transmission by the first pattern with the missing pulse followed by the second pattern. In still more embodiments, the first pattern may correspond to a clock pattern with a configured time duration M, the missing pulse may correspond to a final end detect signal, and the second pattern may correspond to a zero-energy signal with a configured time duration N. The clock pattern may include, for example, one or more C8 patterns, where each C8 pattern may be defined by four Unit Intervals (UIs) at a low voltage and four UIs at a high voltage. Each UI may correspond to one PAM symbol. In still further embodiments, the C8 pattern may refer to a clock with a frequency of ⅛ of the data rate. In still additional embodiments, the power management logic may detect the end-of-transmission as follows. The power management logic may detect a fine position of a potential end-of-transmission by determining an edge position of the first pattern. For example, the power management logic may detect the edge position by selecting one of eight (8) different positions of the C8 pattern. The power management logic may then detect a potential last bit by detecting the missing pulse in the first pattern. While the detection of the missing pulse in the first pattern may be sufficient to detect the last bit of the transmission, this detection may have a high probability of being triggered by ordinary random data. Hence, there may be a high probability that random data may falsely trigger the end-of-transmission. To preclude random data from falsely triggering the end-of-transmission, in some more embodiments, the power management logic may evaluate data after the potential last bit by utilizing the edge position and the position of the missing pulse of the first pattern. In yet various embodiments, the data after the potential last bit must exhibit zero energy to trigger the end-of-transmission. In yet more embodiments, the power management logic may sum the energy of the data after the potential last bit by adding the absolute or abs(x\hat{ }2) values of N samples, and then detect the end-of-transmission based on the potential last bit being detected and the energy over N samples being below a threshold value. In still yet more embodiments, the power management logic may be further configured to transition receiving circuitry in the receiver from a power-up state to a power-down state based on the detection of the end-of-transmission.

In many further embodiments, the systems, devices, and methods discussed herein may apply a Green Mode (GM) power-saving technique to the network devices. The GM may be an advanced power-saving technique configured to reclaim SerDes and Ethernet port power consumption during idle periods. The GM may power down analog circuitry and some portions of the digital circuitry to save power when a link is idle. The GM may implement mechanisms that allow the network devices to enter a power-down state when the link that connects the network devices is idle. Unlike EEE that may only reduce clock speeds or lower voltage levels, the GM may power down both analog circuitry and portions of the digital circuitry, substantially reducing idle power in the network devices. Such power management on the network devices can be executed without manual intervention. Additionally, as the power management may power down both analog circuitry and portions of the digital circuitry, reducing idle power draw may minimize leakage and dynamic power while ensuring rapid link reactivation when data transmission resumes, and hence the energy consumed by the network devices may be less than that consumed by conventional network devices. In many additional embodiments, transmitting circuitry and/or receiving circuitry including, for example, the SerDes circuitry, in the network devices may operate in a power-down state, conserving energy when full performance is not required while maintaining the ability to quickly return to a full-speed operation when needed.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

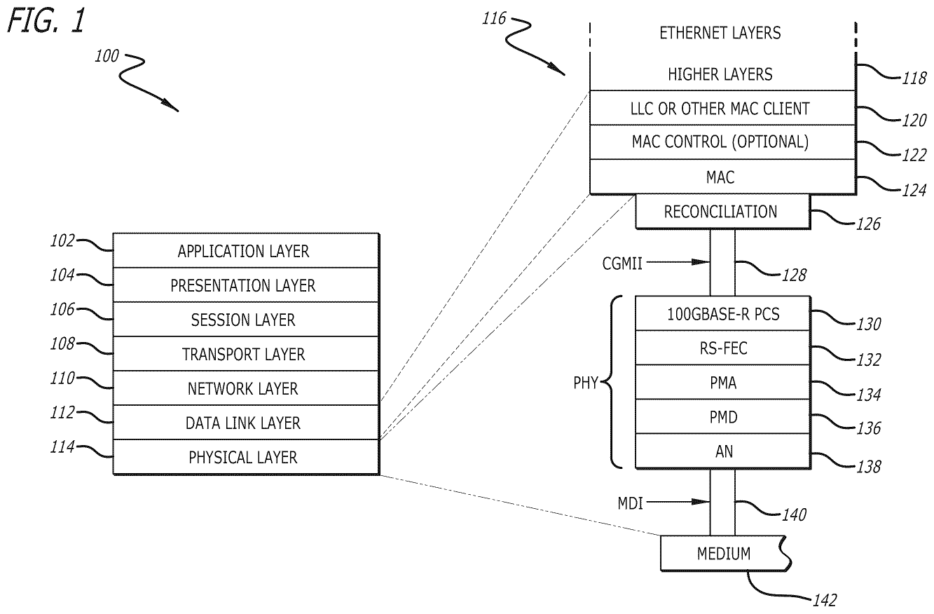

Referring to FIG. 1, a schematic diagram of a communication layer architecture 100 in accordance with various embodiments of the disclosure is shown. In many embodiments, the communication layer architecture 100 may be utilized to carry out various communications described or required herein. In a number of embodiments, the communication layer architecture 100 may be configured as an Open Systems Interconnection (OSI) model. In a variety of embodiments, the communication layer architecture 100 may include seven layers which may be implemented in accordance with the OSI model. The seven layers include, for example, a physical layer 114, a data link layer 112, a network layer 110, a transport layer 108, a session layer 106, a presentation layer 104, and an application layer 102.

In various embodiments, the physical layer 114 may serve as a foundational layer among the seven layers. The physical layer 114 may represent the first layer of the OSI model and may be referred to as “layer 1.” The physical layer 114 may be responsible for an actual physical connection between devices and transmission and reception of raw, unstructured data over a physical medium (denoted as “medium 142”) including, for example, cables such as twisted pair cables, fiber optic cables, or the like, or wireless connections. The physical layer 114 may include physical equipment involved in a data transfer and electrical/optical, mechanical, and functional interfaces to the physical medium. The physical layer 114 may carry signals for the higher layers of the OSI model. The physical layer 114 may provide synchronization of bits through a clock, define a transmission rate, that is, the number of bits transmitted per second, define an arrangement of different devices in a network, and define how the data flows between two connected devices. The devices operating at the physical layer 114 may include network cables such as Ethernet cables, fiber optic cables, or the like, connectors, repeaters, hubs, or the like.

In more embodiments, the data link layer 112 may provide an error-free transfer of data frames from one device to another device over the physical layer 114, allowing the layers 102-110 above the data link layer 112 to assume a substantially error-free transmission over a link. The data link layer 112 may represent the second layer of the OSI model and may be referred to as “layer 2.” The data link layer 112 may be configured to perform framing, error detection and correction, flow control, access control, and addressing. An example of a protocol utilized in the data link layer 112 may be Ethernet. Ethernet may operate in the physical layer 114 and the data link layer 112 of the OSI model. The data link layer 112 may be divided into two sublayers: a Logical Link Control (LLC) or MAC client 120 and a Media Access Control (MAC) sublayer 124. The LLC or MAC client 120 may manage communication between devices on the network and handle error correction, flow control, and data link management. The LLC or MAC client 120 may be responsible for identifying and encapsulating higher-layer protocols such as an Internet Protocol (IP). The MAC sublayer 124 may control how the devices access the physical medium and transmit data. The MAC sublayer 124 may handle the addressing of the devices using MAC addresses, access control methods, and how to handle the data frames when they are ready for transmission. The devices that operate at the data link layer 112 may include, for example, Network Interface Cards (NICs), switches, bridges, or the like. The data link layer 112 may facilitate creation of a reliable point-to-point or point-to-multipoint link for data transmission between neighboring devices.

In additional embodiments, the network layer 110 may control the operation of a subnet, determining which physical path the data should take based on network conditions, priority of service, and other factors. The network layer 110 may represent the third layer of the OSI model and may be referred to as “layer 3.” The network layer 110 may perform logical addressing, routing, and the fragmentation and reassembly of data packets. In further embodiments, the network layer 110 may ensure that the data is directed from a source to a destination, even when the devices are not directly connected. An example of a protocol utilized in the network layer 110 may be IP. The devices that operate at the network layer 110 may include, for example, routers, for routing data between different networks or subnets. The network layer 110 may determine an optimal path for data to traverse through a network based on logical addressing. The network layer 110 may abstract the underlying physical layer 114 and the data link layer 112, allowing for a more scalable and flexible communication infrastructure.

In still more embodiments, the transport layer 108 facilitates delivery of error-free messages, in sequence, and with no losses or duplications. The transport layer 108 may represent the fourth layer of the OSI model and may be referred to as “layer 4.” The transport layer 108 may be responsible for end-to-end communication between two devices. The transport layer 108 may also provide an acknowledgment of a successful data transmission and re-transmit data if an error is found. The transport layer 108 may segment and reassemble the data for transmission between the devices, perform error detection and correction, ensure flow control, and manage data transmission rates. Examples of protocols utilized in the transport layer 108 may include a Transmission Control Protocol (TCP), User Datagram Protocol (UDP), Point-to-Point Tunneling Protocol (PPTP), or the like.

In still further embodiments, the session layer 106 may be responsible for the establishment of connections, management of connections, and terminations of sessions between two devices. The session layer 106 may facilitate session establishment between processes running on different devices. The session layer 106 may represent the fifth layer of the OSI model and may be referred to as “layer 5.” The session layer 106 may synchronize data exchange, allowing for full-duplex, half-duplex, or simplex communication. The session layer 106 may allow a process to add checkpoints that are considered synchronization points in the data. These synchronization points may assist in identifying an error to allow a proper resynchronization of the data, to preclude ends of messages from being cut prematurely, and to avoid data loss. The session layer 106 may manage the sessions between two communicating devices, ensuring that data flows in the correct order.

In still additional embodiments, the presentation layer 104 may format the data for presentation to the application layer 102. The presentation layer 104 may represent the sixth layer of the OSI model and may be referred to as “layer 6.” The presentation layer 104 may be responsible for translation, encryption, and compression of data between the application layer 102 and the transport layer 108. The presentation layer 104 may be viewed as a translator for the network. The presentation layer 104 may translate data from a format utilized by the application layer 102 into a common format at a transmitting network device and then translate the common format to a format known by the application layer 102 at a receiving network device.

In some more embodiments, the application layer 102 may serve as a window for users and application processes to access network services and for displaying received information to the users. The application layer 102 may represent the seventh layer of the OSI model and may be referred to as “layer 7.” The application layer 102 may be implemented by network applications that generate the data to be transmitted over the network. Examples of protocols utilized in the application layer 102 may include a HyperText Transfer Protocol (HTTP), Simple Mail Transfer Protocol (SMTP), File Transfer Protocol (FTP), Domain Name System (DNS), or the like. The application layer 102 may directly interact with end-user applications. The application layer 102 may provide network services to the applications and facilitate user interaction with the network. In yet various embodiments, the application layer 102 may operate as a mediator, allowing different software applications to communicate seamlessly across the network.

Further, the Ethernet interface may be defined by the Institute of Electrical and Electronics Engineers (IEEE) as layers of functions as illustrated in FIG. 1, as captured from the IEEE802.3cx standard. The embodiments illustrated in FIG. 1 are described in the context of Ethernet layers 116 including, for example, a reconciliation layer 126, a MAC sublayer 124, an optional MAC control layer 122, an LLC or other MAC client 120, and higher layers 118. The optional MAC control layer 122, the LLC or other MAC client 120, and the higher layers 118 may be herein referred to as “upper layers 118-122.” The reconciliation layer 126, the MAC sublayer 124, and the upper layers 118-122 may process incoming and outgoing packets and may not operate when the link is idle, and no packets are transmitted or received. In lower layers that are below the reconciliation layer 126, the MAC sublayer 124, and the upper layers 118-122, the packets may be converted into a continuous stream of bits. These bits may be scrambled to guarantee frequent bit transitions from zero to one and vice versa. The continuous scrambled bits may imply that the lower layers are never idle. The lower layers may process the stream of bits even when they do not carry real data traffic.

In yet more embodiments, the reconciliation layer 126 may communicate with the Ethernet PHY layer via a Common Gigabit Media Independent Interface (CGMII) 128. The Ethernet PHY layer may represent a physical layer device. In still yet more embodiments, the CGMII 128 may operate at speeds, for example, up to 1000 Mbps, implemented using a data interface clocked at 125 megahertz (MHz) with separate eight-bit data paths for receive and transmit. In many further embodiments, the CGMII 128 may support 100 Gbps operation through its 64-bit-wide transmit and receive data paths. The Ethernet PHY layer may include 100 GBASE-R Physical Coding Sublayer (PCS) 130, Reed Solomon-Forward Error Correction (RS-FEC) 132, a Physical Medium Attachment (PMA) 134, and a Physical Medium Dependent (PMD) sublayer 136. 100 GBASE-R may represent a group or family of physical layer devices, for example, 100 Gbps transceivers, where “BASE” may refer to a baseband transmission method in which the entire bandwidth of the medium 142 may be utilized to transmit a single data stream. The 100 GBASE-R PCS 130 may be responsible for encoding and decoding data to be transmitted over the medium 142. The RS-FEC 132 may refer to a RS-FEC codeword-interleaved sublayer that may be utilized for error correction during the transmission of the data. In many additional embodiments, the Ethernet PHY layer may include the RS-FEC 132 based on the type of physical layer device. The PMA 134 may refer to a sublayer of the Ethernet PHY layer responsible for providing an interface between the Ethernet PHY layer and the medium 142. The PMA 134 may refer to a sublayer of the Ethernet PHY layer responsible for ensuring that the data is properly encoded or decoded for transmission over the medium 142. The PMA 134 may operate directly with the PMD sublayer 136 to transmit and receive the data, for example, across cables or optical fibers. The PMD sublayer 136 may define the electrical, optical, or radio signals utilize for transmission, and specifications for physical connectors. The PMD sublayer 136 may define characteristics and properties, for example, signal levels, encoding schemes, or the like, of the medium 142, and how the transmission and reception of the data interact with this medium 142.

In still yet further embodiments, the Ethernet PHY layer may implement an Auto-Negotiation (AN) protocol 138 based on the type of physical layer device. The AN protocol 138 may allow the devices on the network to automatically detect and agree on the best possible communication parameters such as speed and duplex mode based on the capabilities of both the devices. The AN protocol 138 may operate at the physical layer 114 to ensure that both the devices on the link can automatically agree on an optimal configuration for communication. The Ethernet PHY layer may communicate with the medium 142 via a Medium Dependent Interface (MDI) 140. The MDI 140 may define how a device physically connects to the medium 142 via the Ethernet interface and how signals are transmitted over that medium 142. The MDI 140 may specify whether the device is connected, for example, to an MDI-X (crossed wiring for a direct connection) or MDI (non-crossed, direct-to-device) interface.

In still yet additional embodiments, the systems, devices, and methods discussed herein dynamically manage power of the Ethernet interface described in the context of Ethernet layers 116 illustrated in FIG. 1. In several embodiments, while the upper layers 118-122 may utilize clock gating techniques for reducing power consumption whenever there is no data traffic, the lower layers may continue to process incoming idle data patterns and consume power. The systems, devices, and methods discussed herein may provide a power management logic configured to power down the PMD sublayer 136 and the upper layers including, for example, the PMA 134, the RS-FEC 132, the 100 GBASE-R PCS 130, the reconciliation layer 126, the MAC sublayer 124, and the upper layers 118-122. Further, the power management logic may implement a power-saving technique configured to reclaim Serializer/Deserializer (SerDes) and Ethernet port power consumption for maintaining links active when there is no data to transmit, for example, during idle periods. A large fraction of power can be saved by rapidly powering down or powering up transmitting circuitry and/or receiving circuitry including, for example, SerDes circuitry. In several more embodiments, the systems, devices, and methods discussed herein provide a method for detecting an end-of-transmission at the receiving network device to allow the receiving network device to determine when the receiving network device can power itself down and up, and distinguish correct data boundaries.

In the systems, devices, and methods discussed herein, the power management logic may signal the end-of-transmission by a first pattern with a missing pulse followed by a second pattern, where the first pattern may correspond to a clock pattern with a configured time duration M, the missing pulse may correspond to a final end detect signal, and the second pattern may correspond to a zero-energy signal with a configured time duration N. The transmitting network device may transmit a data frame and an indication including the first pattern with the missing pulse followed by the second pattern, specifying the end-of-transmission to the receiving network device. The receiving network device may receive the data frame and the indication, and detect the end-of-transmission based on the indication. In numerous embodiments, the indication may provide state knowledge about various aspects of a power status of the transmitting circuitry of the transmitting network device to the receiving network device, thereby facilitating optimal responses and reactive decision-making therewithin. Based on the indication, the receiving network device can make intelligent decisions to transition the receiving circuitry from a power-up state to a power-down state and shutdown idle components when they are not needed, thereby reducing the overall power consumption and improving energy efficiency of the Ethernet interface. In numerous additional embodiments, the systems, devices, and methods discussed herein may dynamically manage power of the Ethernet interface through the detection of the end-of-transmission and subsequent power state transitions.

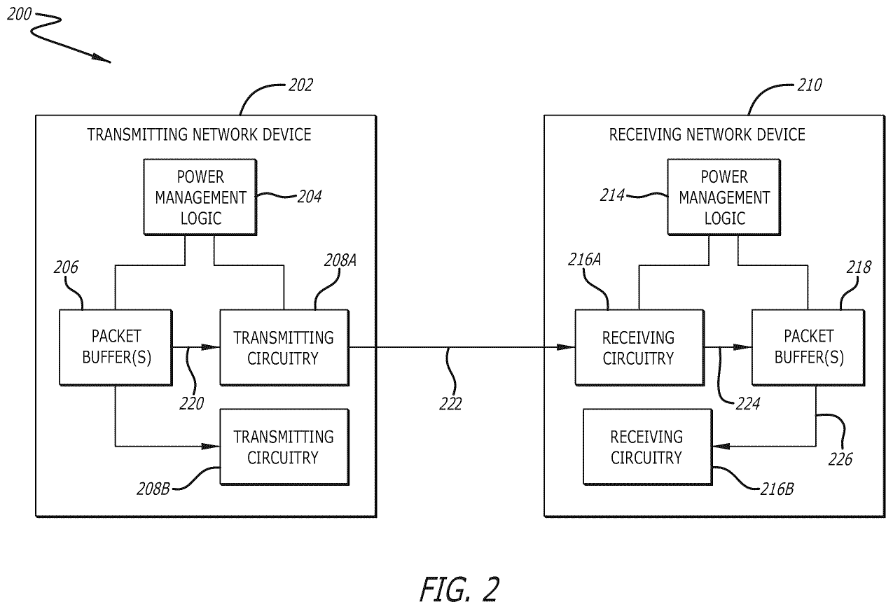

Although a specific embodiment for a communication layer architecture 100 suitable for carrying out the various steps, processes, methods, and operations described herein is discussed with respect to FIG. 1, any of a variety of systems and/or processes may be utilized in accordance with embodiments of the disclosure. For example, various aspects described herein may reside or be carried out on one layer or a plurality of layers of the communication layer architecture 100. The elements depicted in FIG. 1 may also be interchangeable with other elements of FIG. 2-9 as required to realize a particularly desired embodiment.

Referring to FIG. 2, a block diagram of a system 200 for detecting an end-of-transmission in an Ethernet interface in accordance with various embodiments of the disclosure is shown. In many embodiments, the system 200 illustrated in FIG. 2 may be configured for transmission and reception of data over Ethernet and may represent an exemplary implementation of the Ethernet interface. In a number of embodiments, the system 200 may include a transmitter 202 (shown as “transmitting network device) in operable communication with a receiver 210 (shown as “receiving network device”). In a variety of embodiments, the transmitter 202 may include a power management logic 204 configured to indicate an end-of-transmission in the Ethernet interface. The end-of-transmission may indicate that a transmitted data frame has ended and there is no data to transmit.

Those skilled in the art will recognize that the power management logic 204 can include various hardware and/or software deployments and can be configured in a variety of ways. In various embodiments, the power management logic 204 can be configured as a standalone device, exist as a logic in another network device, be distributed among various network devices operating in tandem, or be remotely operated as part of a cloud-based network management system. In more embodiments, one or more servers can be configured with the power management logic 204 or can otherwise operate as the power management logic 204. In additional embodiments, the power management logic 204 may operate on one or more servers connected to a communication network, for example, the internet. The communication network can include wired networks or wireless networks. The power management logic 204 can be provided as a cloud-based service that can service remote networks, such as a deployed network. In further embodiments, the power management logic 204 may be operated as a distributed logic across multiple network devices. For example, a plurality of switches can operate as the power management logic 204 in a distributed manner or may have one specific device operate as the power management logic 204 for all the neighboring or sibling switches.

In still more embodiments, the power management logic 204 may be operably coupled to one or more packet buffers 206 and one or more transmitting circuitries, for example, the transmitting circuitries 208A and 208B. The packet buffer(s) 206 may store data packets, herein referred to as “data”, that may be ready for transmission. When the transmitter 202 needs to transmit data, the data may be first stored in the packet buffer(s) 206. The packet buffer(s) 206 may facilitate data flow and can temporarily hold the data until the data is ready for transmission. One or more of the transmitting circuitries 208A and 208B of the transmitter 202, for example, the transmitting circuitry 208A, may receive the data 220 from the packet buffer(s) 206 for transmission to the receiver 210 via a communication link 222. For the sake of brevity and in a non-limiting example, the transmitter 202 is shown in FIG. 2 to include two transmitting circuitries 208A and 208B for data transmission. However, in an actual implementation, the transmitter 202 can include any number of transmitting circuitries corresponding to different transmitter ports utilized for data transmission.

In still further embodiments, the transmitting circuitries 208A and 208B may include analog circuitry and digital circuitry that are operable in a power-up state or a power-down state. The power-up state may refer to an operational state that one or more components of the transmitter 202 and/or the receiver 210 enter when the component(s) is powered on and initialized for normal data communication including data transmission and data reception. The power-down state may refer to a low-power state in which one or more components of the transmitter 202 and/or the receiver 210 power down or completely shut off their internal circuits and functions to save power when the component(s) is not actively transmitting or receiving data, for example, when the communication link 222 is idle. In still additional embodiments, one or more of the transmitting circuitries 208A and 208B may include a SerDes transmitter that may be operable in a power-up state or a power-down state. In some more embodiments, in the power-up state, the SerDes transmitter may consume full operational power. In the power-up state, the SerDes transmitter may be ready to serialize data from a parallel format of multiple bits to a high-speed serial data stream and transmit the high-speed serial data stream over the communication link 222. In yet various embodiments, the SerDes transmitter may enter the power-down state during idle periods, but during active operation, the SerDes transmitter may run at full power to ensure reliable data transmission. In the power-down state, the SerDes transmitter may substantially reduce its power consumption by shutting down or idling components such as a serializer, a clock generator, and other active circuits. In yet more embodiments, one or more of the transmitting circuitries 208A and 208B may include a MAC transmitter. The MAC transmitter may be a component within the MAC layer of the OSI model, that prepares and processes the data for transmission over a physical network. The MAC transmitter may format the data into Ethernet frames and attach a MAC header, which includes source and destination MAC addresses, as well as control information, thereto. In still yet more embodiments, the MAC transmitter may also handle tasks such as error checking by adding, for example, a checksum or a Cyclic Redundancy Check (CRC), ensuring that the data is in a proper format for transmission. In many further embodiments, the transmitting circuitries 208A and 208B may be correspond to respective transmitter ports, where powering down one transmitter port means disabling its specific signal path, thereby saving power and reducing interference without affecting the functionality of other active transmitter ports. In many additional embodiments, the power management logic 204 may communicate with one or more of the transmitting circuitries 208A and 208B to indicate the end-of-transmission in the Ethernet interface.

The transmitter 202 may be operably coupled to the receiver 210 via the communication link 222. In still yet further embodiments, the communication link 222 may correspond to a data transmission channel, because an additional out-of-band communication channel from the transmitter 202 to the receiver 210 may not be reliable for powering the receiver 210 up and down. The receiver 210 may include a power management logic 214 configured to detect the end-of-transmission in the Ethernet interface. Those skilled in the art will recognize that the power management logic 214 can include various hardware and/or software deployments and can be configured in a variety of ways. In still yet additional embodiments, the power management logic 214 can be configured as a standalone device, exist as a logic in another network device, be distributed among various network devices operating in tandem, or be remotely operated as part of a cloud-based network management system. In several embodiments, one or more servers can be configured with the power management logic 214 or can otherwise operate as the power management logic 214. In several more embodiments, the power management logic 214 may operate on one or more servers connected to the communication network. The power management logic 214 can be provided as a cloud-based service that can service remote networks, such as a deployed network. In numerous embodiments, the power management logic 214 may be operated as a distributed logic across multiple network devices. For example, a plurality of switches can operate as the power management logic 214 in a distributed manner or may have one specific device operate as the power management logic 214 for all the neighboring or sibling switches.

In numerous additional embodiments, the power management logic 214 may be operably coupled to one or more receiving circuitries, for example, the receiving circuitries 216A and 216B, and one or more packet buffers 218. For the sake of brevity and in a non-limiting example, the receiver 210 is shown in FIG. 2 to include two receiving circuitries 216A and 216B for data reception. However, in an actual implementation, the receiver 210 can include any number of receiving circuitries corresponding to different receiver ports utilized for data reception. In further additional embodiments, the receiving circuitries 216A and 216B may include analog circuitry and digital circuitry that are operable in a power-up state or a power-down state. In many embodiments, one or more of the receiving circuitries 216A and 216B may include a SerDes receiver that may be operable in a power-up state or a power-down state. In the power-up state, the SerDes receiver may be powered on, initialized, and ready to receive, detect, synchronize, decode, and deserialize the high-speed serial data stream received from the transmitter 202 into parallel data that can be processed by higher layers of a communication layer architecture. In a number of embodiments, in the power-up state, the SerDes receiver may consume full operational power. In the power-down state, the SerDes receiver may reduce power consumption or completely shut down its internal circuits and functions to conserve energy when the SerDes receiver is not actively receiving or deserializing data. In the power-down state, the SerDes receiver may substantially reduce its power consumption by shutting down or idling components such as a Clock Data Recovery (CDR) mechanism, signal equalization circuits, and other active circuits. In a variety of embodiments, the SerDes transmitter at the transmitter side may be communicatively coupled to the SerDes receiver at the receiver side via their respective serial data lines. In the power-down state, the SerDes transmitter and the SerDes receiver may be inactive, minimizing power consumption while preserving the ability to quickly return to a full operational state when needed.

In various embodiments, one or more of the receiving circuitries 216A and 216B may include a MAC receiver. In more embodiments, the SerDes receiver may transmit the parallel data to the MAC receiver via a parallel data bus. In additional embodiments, the MAC receiver may include a data pipeline configured as a pipeline logic to receive and process the parallel data. The MAC receiver may process the received parallel data, for example, by stripping off the MAC header, checking for errors through the checksum or the CRC, extracting payload data after verifying the destination MAC address, and removing idle data patterns. In further embodiments, the MAC receiver may handle flow control or retransmission requests. The MAC receiver may transmit the processed parallel data to the packet buffer(s) 218.

The packet buffer(s) 218 may store the data received from the transmitter 202. For example, the packet buffer(s) 218 may temporarily store processed parallel data from the MAC receiver, preventing overflow or loss. The packet buffer(s) 218 may manage the flow of incoming data, ensuring that the data is not lost if the system 200 is busy processing other tasks. In still more embodiments, the packet buffer(s) 218 may receive and temporarily store the incoming data 224 from the receiving circuitry 216A and forward one or more portions of the received data 226 to the receiving circuitry 216B.

In still further embodiments, at the transmitter side, the packet buffer(s) 206 may accumulate part of the data before transmission and signal to the power management logic 204 in the transmitter 202, when the packet buffer(s) 206 is empty or non-empty. In still additional embodiments, the power management logic 204 may determine an absence or presence of pending data for processing based on a packet availability status message signaled by the packet buffer(s) 206. The higher layers of the communication layer architecture, for example, the network layer or the transport layer, may generate and hand-off the data to the packet buffer(s) 206. The packet buffer(s) 206 can hold the data temporarily until the data is ready for transmission. When the packet buffer(s) 206 is non-empty, the packet buffer(s) 206 may signal availability of the data to the power management logic 204 via the packet availability status message. In response to this packet availability status message, the power management logic 204 may transmit a signal indicating a start operation to one or more of the transmitting circuitries 208A and 208B. For example, in response to the signal corresponding to the start operation, the transmitting circuitry 208A may receive the data 220 from the packet buffer(s) 206 and proceed to transmit the data 220 to the receiving circuitry 216A at the receiver 210.

In some more embodiments, the transmitting circuitry 208A may ensure that a serial data stream is transmitted bit by bit, maintaining high throughput and reducing the number of pins or wires needed for transmission. The receiving circuitry 216A, operating in the power-up state, may receive the incoming serial data stream via the communication link 222 and process the received serial data stream in the packet buffer(s) 218. For example, the SerDes receiver may convert the serial data stream into parallel data for further processing by the MAC receiver. The packet buffer(s) 218 may store the processed data.

When the packet buffer(s) 206 is empty, the packet buffer(s) 206 may signal unavailability of the data to the power management logic 204 via a packet availability status message. In response to the packet availability status message, the power management logic 204 may transmit a signal indicating a stop operation to the transmitting circuitry 208A. In response to the signal corresponding to the stop operation, the transmitting circuitry 208A may discontinue the reception of the data from the packet buffer(s) 206 and may then proceed to complete the transmission of a last data frame to the receiver 210 via the communication link 222.

In yet various embodiments, the transmitting circuitry 208A, in communication with the power management logic 204, may transmit the last data frame comprising one or more packets. In yet more embodiments, the power management logic 204 may generate an indication specifying an end-of-transmission. The indication may include a first pattern with a missing pulse followed by a second pattern. In still yet more embodiments, the first pattern may extend for a configured time duration. In many further embodiments, the first pattern may correspond to a clock pattern. Further, the missing pulse in the first pattern may correspond to a last pulse of the clock pattern. In many additional embodiments, the second pattern may exhibit energy below a threshold value. In still yet further embodiments, the threshold value may a small value slightly above a noise energy level, selected to balance false positives and false negatives. In still yet additional embodiments, the second pattern may correspond to a zero-energy signal for a configured time duration. A zero-energy signal may refer to a signal where the total energy of the signal, that is, sum or integral of the squared magnitude over time, is zero. In several embodiments, the power management logic 204 may include a pattern generator configured to generate the first pattern with the missing pulse followed by the second pattern. The pattern generator may generate a predefined sequence of digital signals including, for example, 0s and 1s, configured to form the first pattern with the missing pulse. For example, the pattern generator may generate a clock pattern as a sequence of seven (7) pulses, where an eighth pulse is absent or missing. In another example, the pattern generator can deliberately output long stretches of 0s, static logic levels, or a random stream of Pulse Amplitude Modulation (PAM) symbols as the second pattern to simulate no data or an idle period. In several more embodiments, the pattern generator may be incorporated in the transmitter 202 as a separate component operable by the power management logic 204 for generating the first pattern with the missing pulse followed by the second pattern. In numerous embodiments, the power management logic 204 may generate the first pattern with the missing pulse followed by the second pattern, without a pattern generator. In numerous additional embodiments, the first pattern may extend for a first time duration, and the second pattern may extend for a second time duration different from the first time duration.

In further additional embodiments, the power management logic 204 may transmit the indication following a last packet of the data frame. In many embodiments, the power management logic 204 may transmit the indication during a transition of the transmitting circuitry 208A from a power-up state to a power-down state. In a number of embodiments, the power management logic 204 may transmit the indication to the SerDes receiver in the receiving circuitry 216A via the SerDes transmitter in the transmitting circuitry 208A over the communication link 222.

The receiving circuitry 216A, in operable communication with the power management logic 214, may receive the data frame and the indication including the first pattern with the missing pulse followed by the second pattern. The power management logic 214 may detect the end-of-transmission based on the indication. In a variety of embodiments, the power management logic 214 may detect the first pattern with the missing pulse and the second pattern, and in turn the end-of-transmission prior to equalization by an equalizer. In various embodiments, the power management logic 214 may determine an edge position of the first pattern, detect a potential last bit of the data frame based on the missing pulse of the first pattern and the edge position of the first pattern, and evaluate data that follows the potential last bit. In more embodiments, the power management logic 214 may select one of a plurality of positions in the first pattern as the edge position of the first pattern. For example, the power management logic 214 may select one of the 8 positions in a C8 pattern as the edge position of the first pattern. Further, the missing pulse of the first pattern may indicate the potential last bit of the data frame. Furthermore, in additional embodiments, the data that follows the potential last bit may correspond to at least a portion of the second pattern. In further embodiments, the power management logic 214 may detect the end-of-transmission based on the evaluation of the data that follows the potential last bit.

In still more embodiments, the power management logic 214 may evaluate data that follows the potential last bit by determining energy of the data that follows the potential last bit and comparing the energy of the data that follows the potential last bit with a threshold value. In still further embodiments, the power management logic 214 may detect the end-of-transmission based on the energy of the data that follows the potential last bit being below the threshold value. In still additional embodiments, the power management logic 214 may sum the energy of the data after the potential last bit by adding the absolute or abs(x\hat{ }2) values of N samples, and then detect the end-of-transmission based on the potential last bit being detected and the energy over N samples being below a threshold value.

In some more embodiments, the power management logic 214 may communicate with one or more of the receiving circuitries 216A and 216B to detect the end-of-transmission in the Ethernet interface. In yet various embodiments, the power management logic 214 may transition one or more of the receiving circuitries 216A and 216B from a power-up state to a power-down state based on the detection of the end-of-transmission. For example, the power management logic 214 may power down both analog circuitry and portions of the digital circuitry, substantially reducing idle power in the receiver 210. In yet more embodiments, the receiving circuitries 216A and 216B may be correspond to respective receiver ports, where powering down one receiver port means disabling its specific signal path, thereby saving power and reducing interference without affecting the functionality of other active receiving ports. Further, the transmitting circuitries 208A and 208B and/or the receiving circuitries 216A and 216B including, for example, the SerDes circuitry, in the transmitter 202 and the receiver 210, respectively, may operate in the power-down state, conserving energy when full performance is not required while maintaining the ability to quickly return to a full-speed operation when needed.

Although a specific embodiment for a system 200 for detecting an end-of-transmission in an Ethernet interface suitable for carrying out the various steps, processes, methods, and operations described herein is discussed with respect to FIG. 2, any of a variety of systems and/or processes may be utilized in accordance with embodiments of the disclosure. For example, in still yet more embodiments, the power management logic 204 and/or 214 may be integrated within another network device. In an example, a Wireless Local Area Network (LAN) Controller, denoted as “WLC,” may have an integrated power management logic 204 and/or 214 that the WLC can utilize to monitor or control power consumption of a plurality of network devices to which the WLC is connected and allow detection of the end-of-transmission in the Ethernet interface, via either a wired connection or a wireless connection. In many further embodiments, the power management logic 204 and/or 214 may be provided as a device or a software separate from the WLC or the power management logic 204 and/or 214 may be partially or wholly integrated into the WLC. The elements depicted in FIG. 2 may also be interchangeable with other elements of FIG. 1 and FIG. 3-9 as required to realize a particularly desired embodiment.

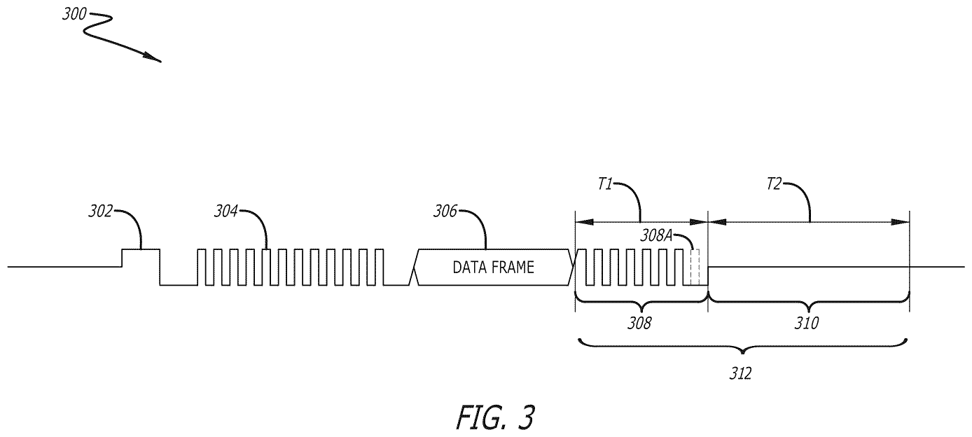

Referring to FIG. 3, a timing diagram 300 for detecting an end-of-transmission in an Ethernet interface in accordance with various embodiments of the disclosure is shown. In an exemplary implementation, the timing diagram 300 illustrates a wake-up pulse 302, followed by a sequence of pulses 304, followed by a data frame 306, and further followed by an indication 312. The wake-up pulse 302 may be configured to wake a network device from a power-down state, when idle, to a power-up state. The sequence of pulses 304 may indicate a start of transmission of the data frame 306 from a transmitting network device, herein referred to as a “transmitter,” to a receiving network device, herein referred to as a “receiver.” The data frame 306 may include the actual payload data to be transmitted to the receiver.

The indication 312 may be configured to specify the end-of-transmission in the Ethernet interface. In many embodiments, the indication 312 may include a first pattern 308 with a missing pulse 308A, and a second pattern 310 exhibiting energy below a threshold value. The first pattern 308 may extend for a configured time duration, for example, T1. In a number of embodiments, the first pattern 308 may correspond to a clock pattern including seven (7) pulses, where the last pulse of the clock pattern, that is, an eighth pulse, may correspond to the missing pulse 308A. As illustrated in FIG. 3, the clock pattern may include, for example, a sequence of eight C8 patterns, where each C8 pattern may be defined by four Unit Intervals (UIs) at a low voltage and four UIs at a high voltage. The clock pattern may, therefore, include 64 UIs, where each UI may correspond to one PAM symbol. In a variety of embodiments, the missing pulse 308A of the clock pattern may provide a potential end detection signal and indicate a potential last bit of the data frame 306. In various embodiments, the second pattern 310 may correspond to a zero-energy signal for a configured time duration, for example, T2. In more embodiments, the time duration, T2, of the second pattern 310 may be different from the time duration, T1, of the first pattern 308. For example, the second pattern 310 may extend for 128 UIs at 0-level.

In an example scenario, the transmitter may be in a power-down state when idle. In additional embodiments, the transmitter may execute a power management logic to indicate the end-of-transmission to the receiver. The power management logic may transmit a short pulse, for example, the wake-up pulse 302, to wake and prepare transmitting circuitry of the transmitter for transmitting the data frame 306. The power management logic may then transmit the sequence of pulses 304, for example, twelve (12) pulses, indicating a start of the transmission of the data frame 306. The power management logic may then transmit the data frame 306 of any length to the receiver. The data frame 306 may include one or more packets. The embodiments herein provide a method for detecting when the data frame 306 ends, precisely at a symbol level. In further embodiments, the power management logic may detect a symbol at which the data frame 306 ends, thereby increasing precision of the end-of-transmission at the symbol level. The power management logic may generate an indication 312 including the first pattern 308 with the missing pulse 308A followed by the second pattern 310, specifying the end-of-transmission. The power management logic may then transmit the indication 312 following the last packet of the data frame 306 to the receiver.

In still more embodiments, the receiver may utilize the wake-up pulse 302 to wake and prepare receiving circuitry of the receiver for receiving the data frame 306 and the indication 312 including the first pattern 308 with the missing pulse 308A followed by the second pattern 310. While the detection of the missing pulse 308A in the first pattern 308 may be sufficient to detect the last bit of the transmission, this detection may have a high probability of being triggered by ordinary random data. To preclude random data from falsely triggering the end-of-transmission, in still further embodiments, the receiver may execute a power management logic to evaluate data after the potential last bit. In still additional embodiments, the data after the potential last bit must exhibit zero energy to trigger the end-of-transmission. In some more embodiments, the power management logic may sum energy of the data after the potential last bit by adding the absolute or abs(x\hat{ }2) values of N samples constituting the second pattern 310, and then detect the end-of-transmission based on the potential last bit being detected and the energy over N samples being below a threshold value.

Although a specific embodiment for detecting an end-of-transmission in an Ethernet interface suitable for carrying out the various steps, processes, methods, and operations described herein is discussed with respect to FIG. 3, any of a variety of systems and/or processes may be utilized in accordance with various embodiments of the disclosure. For example, other than a repeating C8 pattern, the transmitter may transmit any clock pattern with any number of pulses and one or more missing pulses to allow detection of a potential last bit for subsequent detection of the end-of-transmission in the Ethernet interface. The elements depicted in FIG. 3 may also be interchangeable with other elements of FIG. 1-2 and FIG. 4-9 as required to realize a particularly desired embodiment.

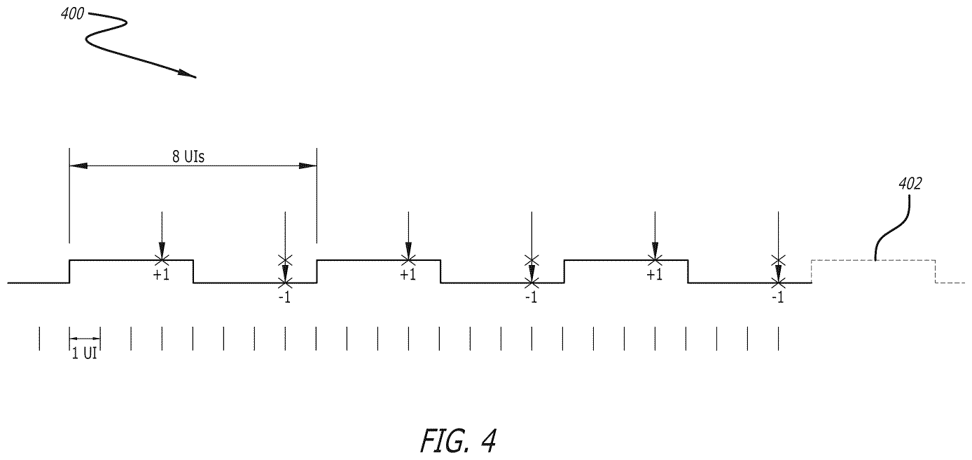

Referring to FIG. 4, a schematic diagram of a clock pattern 400 with a missing pulse 402 configured to identify an end-of-transmission in accordance with various embodiments of the disclosure is shown. The embodiments herein may be described in the context of a clock pattern 400 including, for example, a periodic sequence of C8 patterns with a missing pulse 402 utilized for detecting a potential last bit of a data frame. Each C8 pattern may include 8 UIs defined, for example, by four UIs at a high voltage and four UIs at a low voltage. Each UI may correspond to one symbol, for example, one PAM symbol. The embodiments herein may utilize a PAM-4 signaling scheme defining pulse amplitude modulation with four (4) voltage levels. In many embodiments, in the PAM-4 signaling scheme, each PAM symbol or UI, may carry two (2) bits of data by utilizing one of 4 distinct voltage levels. In a number of embodiments, a receiving network device may include a phase detector configured to detect transitions in the clock pattern 400 and detect where the C8 pattern starts. The missing pulse 402 of the clock pattern 400 may correspond to the last pulse of the clock pattern 400. In a variety of embodiments, the missing pulse 402 of the clock pattern 400 may provide a potential end detection signal and indicate the potential last bit of the data frame. In various embodiments, the receiving network device may execute a power management logic to detect a PAM symbol at which the data frame ends, thereby increasing precision of the end-of-transmission at a symbol level. In an example, the end-of-transmission may be detected at a precision of 2 bits.

Although a specific embodiment for a clock pattern 400 with a missing pulse 402 configured to identify an end-of-transmission suitable for carrying out the various steps, processes, methods, and operations described herein is discussed with respect to FIG. 4, any of a variety of systems and/or processes may be utilized in accordance with various embodiments of the disclosure. For example, in more embodiments, other than a periodic sequence of C8 patterns, the clock pattern may include a periodic sequence of C4 patterns or C6 patterns with a missing pulse utilized for detecting a potential last bit of a data frame. The elements depicted in FIG. 4 may also be interchangeable with other elements of FIG. 1-3 and FIG. 5-9 as required to realize a particularly desired embodiment.

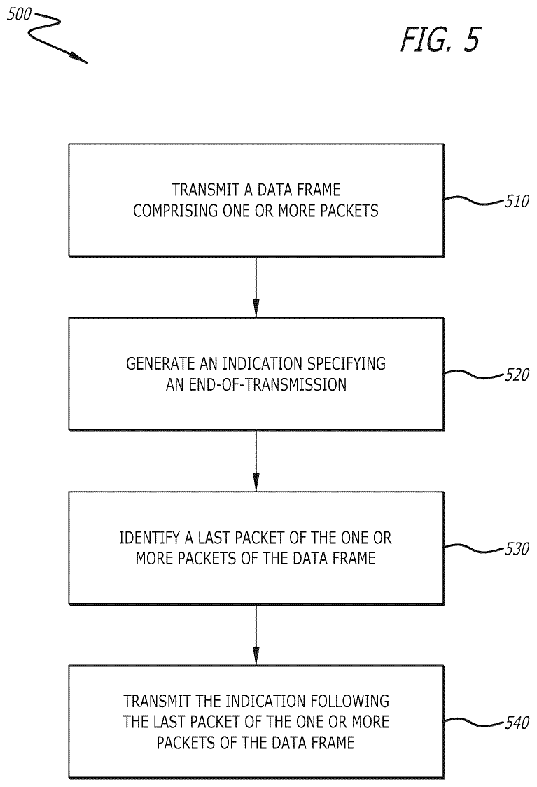

Referring to FIG. 5, a flowchart depicting a process 500 for indicating an end-of-transmission in accordance with various embodiments of the disclosure is shown. In many embodiments, the process 500 may signal the end-of-transmission for a burst mode of transmission. In a number of embodiments, the process 500 may transmit a data frame comprising one or more packets (block 510). The data frame may include the actual payload data to be transmitted. The data frame may be of any length. The process 500 may utilize one or more transmitting circuitries including, for example, a SerDes transmitter, of a transmitter for transmitting the data frame. The process 500 may transmit the data frame to the receiver via a communication link. In a variety of embodiments, the process 500 may utilize a data transmission channel of the communication link to transmit the data frame to the receiver, because an additional out-of-band communication channel from the transmitter to the receiver may not be reliable for powering the receiver up and down.

In various embodiments, the process 500 may generate an indication specifying an end-of-transmission (block 520). In more embodiments, the process 500 may execute a power management logic including a pattern generator for generating the indication at the transmitter. In additional embodiments, the indication may include a first pattern with a missing pulse followed by a second pattern. The first pattern may extend for a configured time duration. In further embodiments, the first pattern may correspond to a clock pattern. The clock pattern may include, for example, one or more C8 patterns, where each C8 pattern may be defined by four UIs at a high voltage and four UIs at a low voltage. Each UI may correspond to one PAM symbol. In still more embodiments, each PAM symbol or UI may carry 2 bits of data. In still further embodiments, the missing pulse may correspond to a last pulse of the clock pattern. The second pattern may exhibit energy below a threshold value. In still additional embodiments, the second pattern may correspond to a zero-energy signal for a configured time duration. In some more embodiments, the configured time duration of the second pattern may be different from the configured time duration of the first pattern.

In yet various embodiments, the process 500 may identify a last packet of the one or more packets of the data frame (block 530). In yet more embodiments, the process 500 may execute the power management logic for identifying the last packet of the data frame at the transmitter. In still yet more embodiments, transmitting circuitry in the transmitter may set a control bit or a symbol in the data frame to allow the process 500 to identify the last packet of the data frame. In many further embodiments, the process 500 may utilize the length of the data frame to identify the last packet of the data frame. The process 500 may identify the last packet of the data frame as the transmitter completes reading a packet buffer or memory holding the data.

In many additional embodiments, the process 500 may transmit the indication following the last packet of the one or more packets of the data frame (block 540). In still yet further embodiments, the process 500 may execute the power management logic to transmit the indication following the last packet of the data frame to the receiver. In still yet additional embodiments, the process 500 may transmit the indication during a transition of the transmitting circuitry of the transmitter from a power-up state to a power-down state. In several embodiments, the process 500 may transmit the indication to receiving circuitry including, for example, a SerDes receiver.

Although a specific embodiment for a process 500 for indicating an end-of-transmission suitable for carrying out the various steps, processes, methods, and operations described herein is discussed with respect to FIG. 5, any of a variety of systems and/or processes may be utilized in accordance with embodiments of the disclosure. For example, in several more embodiments, the process 500 may transmit the indication during a transition of one or more selective portions of the transmitting circuitry such as the SerDes transmitter and/or a MAC transmitter transition from the power-up state to the power-down state. The elements depicted in FIG. 5 may also be interchangeable with other elements of FIG. 1-4 and FIG. 6-9 as required to realize a particularly desired embodiment.

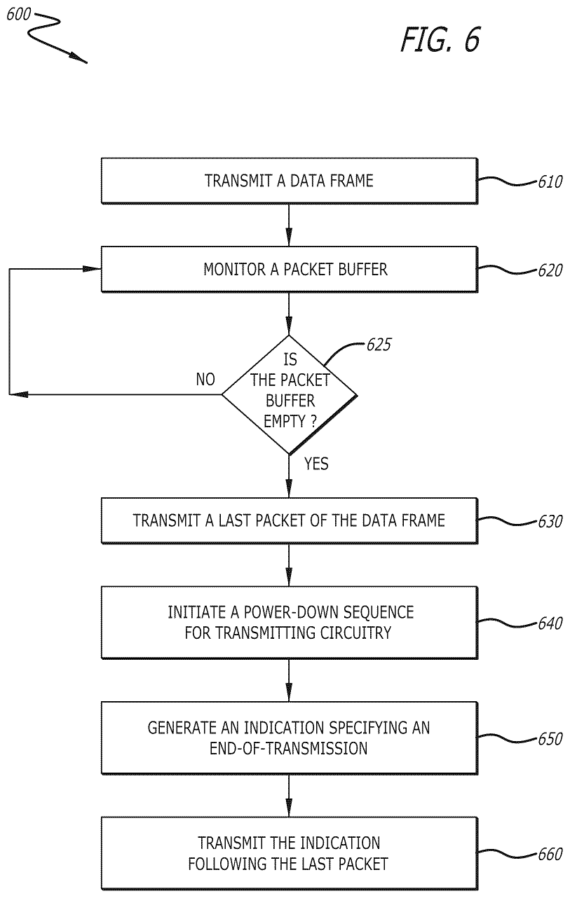

Referring to FIG. 6, a flowchart depicting a process 600 for transmitting an indication specifying an end-of-transmission during a transition from a power-up state to a power-down state in accordance with various embodiments of the disclosure is shown. In many embodiments, the process 600 may signal the end-of-transmission for a burst mode of transmission. In a number of embodiments, the process 600 may transmit a data frame (block 610). The data frame may include one or more packets herein referred to as “data.” When a transmitter needs to transmit data, the data may be first stored in a packet buffer. The data frame may include the actual payload data to be transmitted. The data frame may be of any length. The process 600 may utilize transmitting circuitry including, for example, a SerDes transmitter, of the transmitter for transmitting the data frame including the data received from the packet buffer. The process 600 may transmit the packet(s) of the data frame to the receiver via a communication link.

In a variety of embodiments, the process 600 may monitor a packet buffer (block 620). Higher layers of a communication layer architecture, for example, the network layer or the transport layer, may generate and hand-off data to be transmitted to the packet buffer. The packet buffer can hold the data in the form of packets temporarily until the packets are ready for transmission. The packet buffer may facilitate data flow and can temporarily hold the packets until the packets are ready for transmission. The packet buffer may accumulate some packets before transmission and signal to a power management logic in the transmitter, whether the packet buffer is empty or non-empty. In various embodiments, the process 600 may monitor the packet buffer for presence or absence of the packets.

In more embodiments, the process 600 may determine whether the packet buffer is empty (block 625). In additional embodiments, the process 600 may await a packet availability status message from the packet buffer to determine whether the packet buffer is empty or non-empty. The packet availability status message may indicate availability or unavailability of the packets in the packet buffer. In further embodiments, the process 600 may determine whether the packet buffer is empty based on the packet availability status message signaled by the packet buffer.

In still more embodiments, in response to determining that the packet buffer is not empty, the process 600 may continue monitoring the packet buffer (block 620). Accordingly, the process 600 may continue to await a packet availability status message from the packet buffer. When the packet buffer is not empty, the packet buffer may signal availability of the data to the power management logic in the transmitter via the packet availability status message. In response to this packet availability status message, the power management logic may transmit a signal indicating a start operation to the transmitting circuitry to receive the packets from the packet buffer and proceed to transmit the packets to the receiver.

In still further embodiments, in response to determining that the packet buffer is empty, the process 600 may transmit a last packet of the data frame (block 630). When the packet buffer is empty, the packet buffer may signal unavailability of the data to the power management logic via a packet availability status message. In response to the packet availability status message, the process 600 may execute the power management logic to transmit a signal indicating a stop operation to the transmitting circuitry. In response to the signal corresponding to the stop operation, the transmitting circuitry may discontinue receiving the packets from the packet buffer and may then proceed to complete the transmission of the last packet of the data frame to the receiver via the communication link.

In still additional embodiments, the process 600 may initiate a power-down sequence for transmitting circuitry (block 640). Based on the power-down sequence, the process 600 may transition one or more portions of the transmitting circuitry, for example, the SerDes transmitter, from a power-up state to a power-down state. In some more embodiments, through the power-down sequence, the process 600 may provide an indication to the SerDes transmitter regarding the transmission of the last packet of the data frame. In yet various embodiments, based on the indication, the SerDes transmitter may suspend data retrieval from the packet buffer and transition to the power-down state.

In yet more embodiments, the process 600 may generate an indication specifying an end-of-transmission (block 650). In still yet more embodiments, the process 600 may execute the power management logic including a pattern generator for generating the indication at the transmitter. In many further embodiments, the indication may include a first pattern with a missing pulse followed by a second pattern. The first pattern may extend for a configured time duration. In many additional embodiments, the first pattern may correspond to a clock pattern. The clock pattern may include, for example, one or more C8 patterns, where each C8 pattern may be defined by four UIs at a high voltage and four UIs at a low voltage. Each UI may correspond to one PAM symbol. In still yet further embodiments, each PAM symbol or UI may carry 2 bits of data. In still yet additional embodiments, the missing pulse may correspond to a last pulse of the clock pattern. The second pattern may exhibit energy below a threshold value. In several embodiments, the second pattern may correspond to a zero-energy signal for a configured time duration. In several more embodiments, the configured time duration of the second pattern may be different from the configured time duration of the first pattern.

In numerous embodiments, the process 600 may transmit the indication following the last packet (block 660). In numerous additional embodiments, the process 600 may execute the power management logic for identifying the last packet of the data frame at the transmitter. The process 600 may identify the last packet of the data frame as the transmitter completes reading the packet buffer. In further additional embodiments, the process 600 may execute the power management logic to transmit the indication following the last packet of the data frame to the receiver. In many embodiments, the process 600 may transmit the indication during the transition of one or more portions of the transmitting circuitry from the power-up state to the power-down state. In a number of embodiments, the process 600 may transmit the indication to receiving circuitry including, for example, a SerDes receiver.

Although a specific embodiment for a process 600 for transmitting an indication specifying an end-of-transmission during a transition from a power-up state to a power-down state suitable for carrying out the various steps, processes, methods, and operations described herein is discussed with respect to FIG. 6, any of a variety of systems and/or processes may be utilized in accordance with embodiments of the disclosure. For example, in a variety of embodiments, the process 600 may implement a software-controlled Power Management Unit (PMU) configured to manage the transitions of the power states of the transmitting circuitry including the SerDes transmitter. In various embodiments, the transmitting circuitry may automatically detect idle or low-traffic periods through internal monitoring, for example, by detecting no data transmission, and autonomously enter the power-down state without requiring explicit control from the PMU. The elements depicted in FIG. 6 may also be interchangeable with other elements of FIG. 1-5 and FIG. 7-9 as required to realize a particularly desired embodiment.

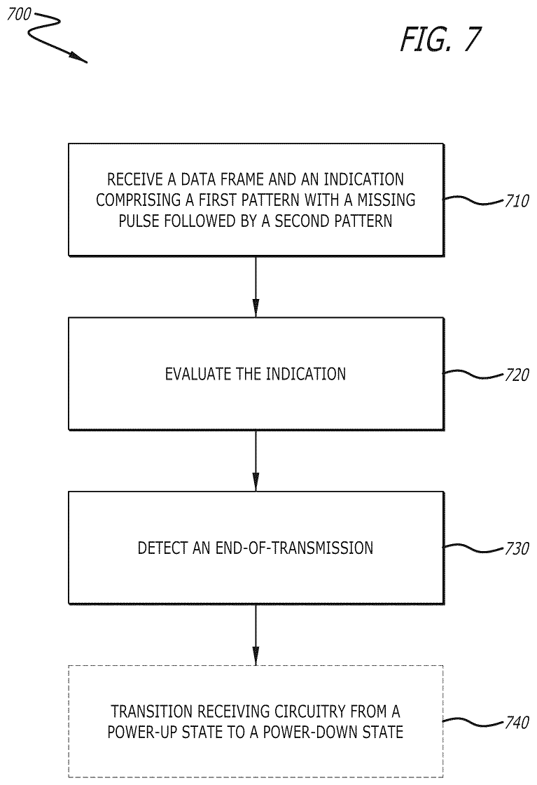

Referring to FIG. 7, a flowchart depicting a process 700 for detecting an end-of-transmission in an Ethernet interface in accordance with various embodiments of the disclosure is shown. In many embodiments, the process 700 may receive a data frame and an indication comprising a first pattern with a missing pulse followed by a second pattern (block 710). The process 700 may receive the data frame and the indication transmitted by a transmitter. The process 700 may receive the data frame and the indication at one or more receiving circuitries of a receiver via a communication link. The data frame may include one or more packets. The data frame may include the actual payload data to be transmitted. The data frame may be of any length. In a number of embodiments, the first pattern of the indication may extend for a configured time duration. In a variety of embodiments, the first pattern may correspond to a clock pattern. The clock pattern may include, for example, one or more C8 patterns, where each C8 pattern may be defined by four UIs at a high voltage and four UIs at a low voltage. Each UI may correspond to one PAM symbol. In various embodiments, each PAM symbol or UI may carry 2 bits of data. In more embodiments, the missing pulse may correspond to a last pulse of the clock pattern. In additional embodiments, the missing pulse may identify a potential last bit of the transmission. The second pattern of the indication may exhibit energy below a threshold value. In further embodiments, the second pattern may correspond to a zero-energy signal for a configured time duration. In still more embodiments, the configured time duration of the second pattern may be different from the configured time duration of the first pattern.

In still further embodiments, the process 700 may evaluate the indication (block 720). By evaluating the indication, the process 700 may detect a fine position of a potential end-of-transmission by determining an edge position of the first pattern of the indication. For example, the process 700 may detect the edge position by selecting one of 8 different positions of the C8 pattern. The process 700 may then detect a potential last bit by detecting the missing pulse in the first pattern. While the detection of the missing pulse in the first pattern of the indication may be sufficient to detect the last bit of the transmission, this detection may have a high probability of being triggered by ordinary random data. To preclude random data from falsely triggering the end-of-transmission, in still additional embodiments, the process 700 may evaluate data that follows the potential last bit. The data that follows the potential last bit may correspond to at least a portion of the second pattern of the indication. In yet various embodiments, the data after the potential last bit must exhibit zero energy to trigger the end-of-transmission.

In yet more embodiments, the process 700 may detect an end-of-transmission (block 730). The process 700 may detect the end-of-transmission based on the indication. In still yet more embodiments, the process 700 may detect the end-of-transmission based on the evaluation of the data that follows the potential last bit. In the evaluation of the data that follows the potential last bit, the process 700 may determine energy of the data that follows the potential last bit, and compare the energy of the data that follows the potential last bit with a threshold value. In many further embodiments, the process 700 may detect the end-of-transmission based on the energy of the data that follows the potential last bit being below the threshold value. In many additional embodiments, the process 700 may sum energy of the data after the potential last bit by adding the absolute or abs(x\hat{ }2) values of N samples constituting the second pattern, and then detect the end-of-transmission based on the potential last bit being detected and the energy over N samples being below the threshold value.

In still yet further embodiments, the process 700 may optionally transition receiving circuitry from a power-up state to a power-down state (block 740). The process 700 may transition the receiving circuitry from the power-up state to the power-down state based on the detection of the end-of-transmission. Upon detecting the end-of-transmission based on the potential last bit being detected and the energy of the data that follows the potential last bit being below the threshold value, the process 700 may initiate a power-down sequence at the receiver. Based on the power-down sequence, the process 700 may transition one or more portions of the receiving circuitry including, for example, a SerDes receiver, from the power-up state to the power-down state. In still yet additional embodiments, through the power-down sequence, the process 700 may provide an indication to the SerDes receiver regarding the detection of the end-of-transmission. In several embodiments, based on the indication, the SerDes receiver may suspend data reception from the transmitter and transition to the power-down state.

Although a specific embodiment for a process 700 for detecting an end-of-transmission in an Ethernet interface suitable for carrying out the various steps, processes, methods, and operations described herein is discussed with respect to FIG. 7, any of a variety of systems and/or processes may be utilized in accordance with embodiments of the disclosure. For example, in several more embodiments, the process 700 may detect the potential last bit based on any clock pattern, other than the C8 pattern, with any number of pulses and one or more missing pulses in the clock pattern. The elements depicted in FIG. 7 may also be interchangeable with other elements of FIG. 1-6 and FIG. 8-9 as required to realize a particularly desired embodiment.

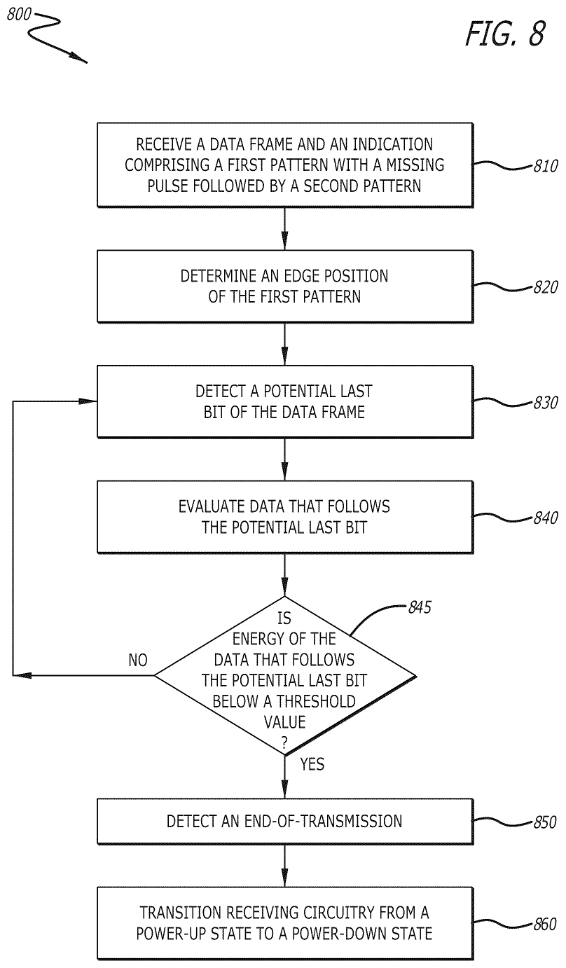

Referring to FIG. 8, a flowchart depicting a process 800 for managing power of an Ethernet interface based on detection of an end-of-transmission in accordance with various embodiments of the disclosure is shown. In many embodiments, the process 800 may receive a data frame and an indication comprising a first pattern with a missing pulse followed by a second pattern (block 810). The process 800 may receive the data frame and the indication transmitted by a transmitter. The process 800 may receive the data frame and the indication at one or more receiving circuitries of a receiver via a communication link. The data frame may include one or more packets. The data frame may include the actual payload data to be transmitted. The data frame may be of any length. In a number of embodiments, the first pattern of the indication may extend for a configured time duration. In a variety of embodiments, the first pattern may correspond to a clock pattern. The clock pattern may include, for example, one or more C8 patterns, where each C8 pattern may be defined by four UIs at a high voltage and four UIs at a low voltage. Each UI may correspond to one PAM symbol. In various embodiments, each PAM symbol or UI may carry 2 bits of data. In more embodiments, the missing pulse may correspond to a last pulse of the clock pattern. In additional embodiments, the missing pulse may identify a potential last bit of the transmission. The second pattern of the indication may exhibit energy below a threshold value. In further embodiments, the second pattern may correspond to a zero-energy signal for a configured time duration. In still more embodiments, the configured time duration of the second pattern may be different from the configured time duration of the first pattern.

In still further embodiments, the process 800 may determine an edge position of the first pattern (block 820). The process 800 may detect a fine position of a potential end-of-transmission by determining the edge position of the first pattern of the indication. The edge position may, for example, be a rising edge of the first pattern. In still additional embodiments, the process 800 may select one of a plurality of positions in the first pattern as the edge position of the first pattern. For example, the process 800 may select one of 8 positions in a C8 pattern as the edge position of the first pattern.

In some more embodiments, the process 800 may detect a potential last bit of the data frame (block 830). The process 800 may detect the potential last bit of the data frame based on the edge position of the first pattern. The process 800 may further detect the potential last bit of the data frame based on the missing pulse of the first pattern. In yet various embodiments, the missing pulse of the first pattern may provide a potential end detection signal. The missing pulse of the first pattern may indicate the potential last bit of the data frame.

In yet more embodiments, the process 800 may evaluate data that follows the potential last bit (block 840). While the detection of the missing pulse in the first pattern may be sufficient to detect the last bit of the transmission, this detection may have a high probability of being triggered by ordinary random data. To preclude random data from falsely triggering the end-of-transmission, in still yet more embodiments, the process 800 may evaluate data after the potential last bit. In many further embodiments, the data after the potential last bit must exhibit zero energy to trigger the end-of-transmission. In many additional embodiments, zero-energy may refer to energy that is less than a small percentage of an expected or nominal signal energy.

In still yet further embodiments, the process 800 may determine whether energy of the data that follows the potential last bit is below a threshold value (block 845). In still yet additional embodiments, the threshold value may a small value slightly above a noise energy level, selected to balance false positives and false negatives. The process 800 may determine energy of the data that follows the potential last bit. In several embodiments, the process 800 may sum the energy of the data after the potential last bit. For example, the process 800 may add the absolute or abs(x\hat{ }2) values of N samples constituting the second pattern of the indication. The process 800 may then compare the energy of the data that follows the potential last bit with the threshold value. In several more embodiments, the process 800 may detect the end-of-transmission based on the energy of the data that follows the potential last bit being below the threshold value. In numerous embodiments, in response to determining that the energy of the data that follows the potential last bit is not below a threshold value, the process 800 may repeat the step of detecting a potential last bit of the data frame (block 830).

In numerous additional embodiments, in response to determining that the energy of the data that follows the potential last bit is below a threshold value, the process 800 may detect an end-of-transmission (block 850). In further additional embodiments, the process 800 may compare the sum of the energy of the data after the potential last bit with the threshold value to determine whether the energy of the data that follows the potential last bit is below the threshold value. For example, the process 800 may compare the sum of the absolute or abs(x\hat{ }2) values of N samples constituting the second pattern of the indication with the threshold value. The process 800 may then detect the end-of-transmission based on the potential last bit being detected and the sum of the energy over N samples being below the threshold value.

In many embodiments, the process 800 may transition receiving circuitry from a power-up state to a power-down state (block 860). The process 800 may transition the receiving circuitry from the power-up state to the power-down state based on the detection of the end-of-transmission. Upon detecting the end-of-transmission based on the potential last bit being detected and the energy of the data that follows the potential last bit being below the threshold value, the process 800 may initiate a power-down sequence at the receiver. Based on the power-down sequence, the process 800 may transition one or more portions of the receiving circuitry including, for example, a SerDes receiver, from the power-up state to the power-down state. In a number of embodiments, through the power-down sequence, the process 800 may provide an indication to the SerDes receiver regarding the detection of the end-of-transmission. In a variety of embodiments, based on the indication, the SerDes receiver may suspend data reception from the transmitter and transition to the power-down state. The process 800, therefore, applies a green mode power-saving technique configured to reclaim SerDes and Ethernet port power consumption during idle periods. In various embodiments, the process 800 may power down both analog circuitry and some portions of the digital circuitry, substantially reducing idle power in the transmitter and/or the receiver.

Although a specific embodiment for a process 800 for managing power of an Ethernet interface based on detection of an end-of-transmission suitable for carrying out the various steps, processes, methods, and operations described herein is discussed with respect to FIG. 8 any of a variety of systems and/or processes may be utilized in accordance with embodiments of the disclosure. For example, the process 800 may receive any excitation signal from the transmitter to indicate a start and an end of a power-down state in the transmitter to initiate the power-down sequence and transition the receiving circuitry from the power-up state to the power-down state. The elements depicted in FIG. 8 may also be interchangeable with other elements of FIG. 1-7 and FIG. 9 as required to realize a particularly desired embodiment.

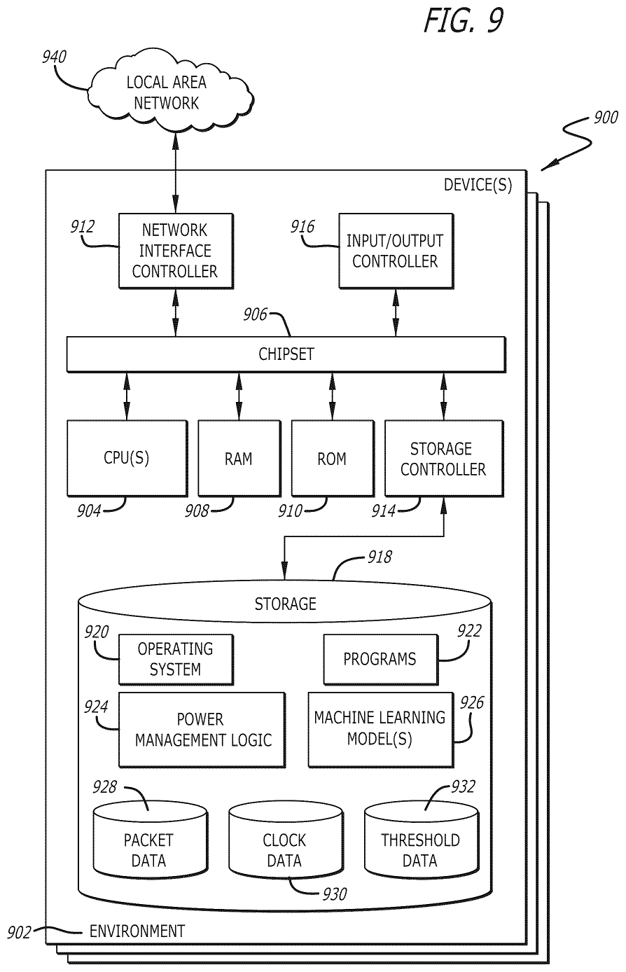

Referring to FIG. 9, a conceptual block diagram of a device 900 suitable for configuration with a power management logic 924 for implementing the functionality and various embodiments of the disclosure is shown. The embodiment of the device 900 in the conceptual block diagram depicted in FIG. 9 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 900 may, in some examples, correspond to a physical device or to a virtual resource described herein. The device 900 can be a network device, for example, an access point, a router, a switch, any type of edge-based network device, a server, a system, or the like in accordance with various embodiments of the disclosure.

In many embodiments, the device 900 may include an environment 902 such as a baseboard or a “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In a number of embodiments, one or more processors 904 such as, but not limited to, Central Processing Units (denoted as “CPU(s)”), can be configured to operate in conjunction with a chipset 906. The processor(s) 904 can be standard programmable CPUs that perform arithmetic and logical operations necessary for the operation of the device 900.

In a variety of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, or the like.

In various embodiments, the chipset 906 may provide an interface between the processor(s) 904 and the remainder of the components and devices within the environment 902. The chipset 906 can provide an interface to a Random-Access Memory (RAM) 908, which can be utilized as the main memory in the device 900 in some embodiments. The chipset 906 can further be configured to provide an interface to a computer-readable storage medium such as a Read-Only Memory (ROM) 910 or a Non-Volatile RAM (NVRAM) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940 (shown as “Local Area Network 940”). The chipset 906 can include functionality for providing network connectivity through a Network Interface Controller (NIC) 912, which may include a gigabit Ethernet adapter or similar component. The NIC 912 can be capable of connecting the device 900 to other devices over the network 940. It is contemplated that multiple NICs 912 may be present in the device 900, connecting the device 900 to other types of networks and remote systems.

In more embodiments, the device 900 can be connected to a storage 918 that provides non-volatile storage for data accessible by the device 900. The storage 918 can, for example, store an operating system 920, applications or programs 922, packet data 928, clock data 930, and threshold data 932, which are described in greater detail below. The storage 918 can be connected to the environment 902 through a storage controller 914 connected to the chipset 906. In additional embodiments, the storage 918 can include one or more physical storage units. The storage controller 914 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 900 can store data within the storage 918 by transforming the physical state of the physical storage units to reflect the information being stored. The specific transformation of the physical state can depend on various factors. Examples of such factors can include, but are not limited to, the technology utilized to implement the physical storage units, whether the storage 918 is characterized as primary or secondary storage, and the like. For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to the device 900. Stated otherwise, some or all of the operations performed by the cloud computing network, and or any components included therein, may be performed by the device 900 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 918 can store an operating system 920 utilized to control the operation of the device 900. According to one embodiment, the operating system 920 includes the LINUX operating system. According to another embodiment, the operating system 920 includes the Windows® server operating system from Microsoft Corporation of Redmond, Washington. According to further embodiments, the operating system 920 can include the UNIX operating system or one of its variants. It should be appreciated that other operating systems can also be utilized. The storage 918 can store other system or application programs and data utilized by the device 900.

In still more embodiments, the storage 918 or other computer-readable storage media is encoded with computer-executable instructions which, when loaded into the device 900, may transform the device 900 from a general-purpose computing system into a special-purpose computer capable of implementing the embodiments described herein. These computer-executable instructions may be stored as applications or programs 922 and transform the device 900 by specifying how the processor(s) 904 can transition between states, as described above. In still further embodiments, the device 900 has access to computer-readable storage media storing computer-executable instructions which, when executed by the device 900, perform the various processes described above with regard to FIG. 1-8. In still additional embodiments, the device 900 can also include computer-readable storage media having instructions stored thereupon for performing any of the other computer-implemented operations described herein.

In some more embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 may not include all of the components shown in FIG. 9, and can include other components that are not explicitly shown in FIG. 9, or may utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In yet various embodiments, the device 900 can include a power management logic 924 that may be responsible for detecting an end-of-transmission in an Ethernet interface. In yet more embodiments, the power management logic 924 may operate in an automation system. In embodiments where the device 900 corresponds to a transmitting network device, the power management logic 924 can be configured to perform various operations such as, but not limited to, transmitting a data frame comprising one or more packets, generating an indication specifying an end-of-transmission, wherein the indication comprises a first pattern with a missing pulse followed by a second pattern, and transmitting the indication following a last packet of the one or more packets of the data frame. In embodiments where the device 900 corresponds to a receiving network device, the power management logic 924 can be configured to perform various operations such as, but not limited to, receiving a data frame and an indication comprising a first pattern with a missing pulse followed by a second pattern, and detecting an end-of-transmission based on the indication. In still yet more embodiments where the device 900 corresponds to the receiving network device, the power management logic 924 can be configured to perform various operations such as, but not limited to, determining an edge position of the first pattern, detecting a potential last bit of the data frame based on the missing pulse of the first pattern and the edge position of the first pattern, and evaluating data that follows the potential last bit, wherein: the data that follows the potential last bit corresponds to at least a portion of the second pattern, and the detection of the end-of-transmission is based on the evaluation of the data.

Those skilled in the art will recognize that the power management logic 924 can include various hardware and/or software deployments and can be configured in a variety of ways. In many additional embodiments, the power management logic 924 can be configured as a standalone device, exist as a logic in another network device, be distributed among various network devices operating in tandem, or remotely operated as part of a cloud-based network management tool. In still yet further embodiments, one or more servers can be configured with the power management logic 924 or can otherwise operate as the power management logic 924. In still yet additional embodiments, the power management logic 924 may operate on one or more servers connected to a communication network, for example, the Internet. The communication network can include wired networks or wireless networks. The power management logic 924 can be provided as a cloud-based service that can service remote networks, such as, but not limited to, a deployed network. Further, in several embodiments, the power management logic 924 may be operated as a distributed logic across multiple network devices. In an embodiment, the controller can operate as the power management logic 924 or may have multiple devices operate as the power management logic 924 in a distributed manner.

In several more embodiments, the storage 918 can include packet data 928. The packet data 928 may relate to data representative of packets that may be ready for transmission. The packet data 928 may include, for example, headers with instructions and metadata, payload data, and trailers including error-checking data. In numerous embodiments, the packet data 928 may include a data stream processed within a data pipeline in transmitting circuitry and residual processed data contained therein prior to transmission to the receiving network device. The packet data 928 may be included in the data frame prior to transmission of the data frame to the receiving network device.

In numerous additional embodiments, the storage 918 can include clock data 930. The clock data 930 may relate to data representative of the first pattern with the missing pulse included in the indication generated by the power management logic 924. The clock data 930 may refer to data of a clock pattern including one or more C8 patterns, where each C8 pattern may be defined by four UIs at a high voltage and four UIs at a low voltage. Each UI may correspond to one PAM symbol. In further additional embodiments, each PAM symbol or UI may carry 2 bits of data. In many embodiments, the missing pulse may correspond to a last pulse of the clock pattern. In a number of embodiments, the missing pulse may identify a potential last bit of the transmission.

In a variety of embodiments, the storage 918 can include threshold data 932. The threshold data 932 may relate to data representative of a threshold value against which data that follows the potential last bit is evaluated to detect an end-of-transmission. The power management logic 924 may compare the energy of the data that follows the potential last bit with the threshold value, and may detect the end-of-transmission based on the energy of the data that follows the potential last bit being below the threshold value.

In various embodiments, data may be processed into a format usable by a Machine Learning (ML) model(s) 926 (e.g., feature vectors), and/or other pre-processing techniques. The ML model(s) 926 may be any type of ML model(s), such as supervised models, reinforcement models, and/or unsupervised models. The ML model(s) 926 may include one or more of linear regression models, logistic regression models, decision trees, Naïve Bayes models, neural networks, k-means cluster models, random forest models, and/or other types of ML models. In more embodiments, the ML model(s) 926 may be configured to evaluate the indication and the data that follows the potential last bit. In additional embodiments, the ML model(s) 926 may be configured to analyze the clock data 930 and the threshold data 932 to extract relevant indications and identifiers for detecting the end-of-transmission.

The ML model(s) 926 can be configured to generate inferences to make predictions or draw conclusions from data. An inference can be considered the output of a process of applying a model to new data. This can occur by learning from at least the packet data 928, the clock data 930, and the threshold data 932. These predictions are based on patterns and relationships discovered within the data. To generate an inference, the trained model can take input data and produce a classification result. The input data can be in various forms, such as text, numerical data, or packet data depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes. Further, the ML model(s) 926 may be configured to process the indication specifying the end-of-transmission based on the clock data 930 and the threshold data 932. For example, the ML model(s) 926 may examine the clock data 930 for identifying the missing pulse and may examine the energy of the data following the potential last bit with respect to the threshold data 932 to detect the end-of-transmission. By learning from the clock data 930, the ML model(s) 926 can predict the missing pulse present in the clock pattern. In other words, once trained, the ML model(s) 926 may be further deployed on the device 900, for example, a transmitter, a receiver, a remitter, a transceiver, or the like, for power management in the Ethernet interface.

Although a specific embodiment for a device 900 suitable for configuration with the power management logic 924 for carrying out the various steps, processes, methods, and operations described herein is discussed with respect to FIG. 9, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the power management logic 924 acts in tandem between the devices. The elements depicted in FIG. 9 may also be interchangeable with other elements of FIG. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A transmitting network device, comprising:
one or more processors; and
a memory communicatively coupled to the one or more processors, wherein the memory comprises a power management logic that is configured to:
transmit a data frame comprising one or more packets;
generate an indication specifying an end-of-transmission, wherein the indication comprises a first pattern with a missing pulse followed by a second pattern; and
transmit the indication following a last packet of the one or more packets of the data frame.

2. The transmitting network device of claim 1, wherein the first pattern extends for a configured time duration.

3. The transmitting network device of claim 1, wherein the first pattern corresponds to a clock pattern.

4. The transmitting network device of claim 3, wherein the missing pulse corresponds to a last pulse of the clock pattern.

5. The transmitting network device of claim 1, wherein the second pattern exhibits energy below a threshold value.

6. The transmitting network device of claim 1, wherein the second pattern corresponds to a zero-energy signal for a configured time duration.

7. The transmitting network device of claim 1, wherein the first pattern extends for a first time duration, and the second pattern extends for a second time duration different from the first time duration.

8. The transmitting network device of claim 1, wherein a transmission of the indication is during a transition from a power-up state to a power-down state.

9. The transmitting network device of claim 1, wherein a transmission of the indication is to a Serializer/Deserializer receiver.

10. A receiving network device, comprising:
one or more processors; and
a memory communicatively coupled to the one or more processors, wherein the memory comprises a power management logic that is configured to:
receive a data frame and an indication comprising a first pattern with a missing pulse followed by a second pattern; and
detect an end-of-transmission based on the indication.

11. The receiving network device of claim 10, wherein the first pattern corresponds to a clock pattern.

12. The receiving network device of claim 11, wherein the missing pulse corresponds to a last pulse of the clock pattern.

13. The receiving network device of claim 10, wherein the first pattern extends for a first time duration, and the second pattern extends for a second time duration different from the first time duration.

14. The receiving network device of claim 10, wherein the power management logic is further configured to:
determine an edge position of the first pattern;
detect a potential last bit of the data frame based on the missing pulse of the first pattern and the edge position of the first pattern; and
evaluate data that follows the potential last bit, wherein:
the data that follows the potential last bit corresponds to at least a portion of the second pattern, and
the detection of the end-of-transmission is based on the evaluation of the data.

15. The receiving network device of claim 14, wherein the determination of the edge position of the first pattern comprises selecting one of a plurality of positions in the first pattern.

16. The receiving network device of claim 14, wherein the evaluation of the data that follows the potential last bit comprises:
determining energy of the data that follows the potential last bit; and
comparing the energy of the data that follows the potential last bit with a threshold value.

17. The receiving network device of claim 16, wherein the detection of the end-of-transmission is based on the energy of the data that follows the potential last bit being below the threshold value.

18. The receiving network device of claim 10, wherein the second pattern corresponds to a zero-energy signal for a configured time duration.

19. The receiving network device of claim 10, further comprising receiving circuitry, wherein the power management logic is further configured to transition the receiving circuitry from a power-up state to a power-down state based on the detection of the end-of-transmission.

20. A method, comprising:
receiving a data frame and an indication comprising a first pattern with a missing pulse followed by a second pattern; and
detecting an end-of-transmission based on the indication.
